(19) United States
(12) Patent Application Publication
(10) Pub. No.: US 2026/0311933 A1
(43) Pub. Date: Oct. 8, 2026

(54) DIELECTRIC CERAMIC, METHOD OF PREPARING THE SAME, AND MULTILAYER CERAMIC CAPACITOR INCLUDING THE SAME

(71) Applicant: SAMSUNG ELECTRO-MECHANICS CO., LTD., Suwon-si (KR)

(72) Inventors: Eunyoung Lee, Suwon-si (KR); Seunghun Kang, Suwon-si (KR); Wonhee Cha, Suwon-si (KR); Jaehoon Ji, Suwon-si (KR); Dohoon Kim, Suwon-si (KR); Kyung-Ryul Lee, Suwon-si (KR); Miso Kim, Daejeon (KR); Hyungyong Kim, Suwon-si (KR)

(73) Assignee: SAMSUNG ELECTRO-MECHANICS CO., LTD., Suwon-si (KR)

(21) Appl. No.: 19/396,208

(22) Filed: Nov. 20, 2025

(30) Foreign Application Priority Data
Apr. 8, 2025 (KR) 10-2025-0045285
May 20, 2025 (KR) 10-2025-0065715

(51) Int. Cl. H01G 4/12; C04B 35/495; C04B 35/626; C04B 35/64; C04B 37/00; H01G 4/30

(52) U.S. Cl. CPC H01G 4/1236; C04B 35/495; C04B 35/62675; C04B 35/62695; C04B 35/64; C04B 37/001; H01G 4/30; C04B 2235/3248; C04B 2235/3255; C04B 2235/3272; C04B 2235/442; C04B 2235/656; C04B 2235/785; C04B 2237/345; C04B 2237/68

(57) ABSTRACT

A dielectric ceramic including a KNN-SZ compound represented by Chemical Formula 1 and iron oxide is disclosed. The dielectric ceramic exhibits a high dielectric constant and excellent temperature stability. A method for preparing the dielectric ceramic includes mixing K-, Na-, Nb-, Sr-, Zr-containing compounds and iron oxide, followed by calcining, compressing, and sintering to form the ceramic. A multilayer ceramic capacitor including the dielectric ceramic as a dielectric layer provides enhanced dielectric performance and reliability suitable for high-temperature and automotive applications,

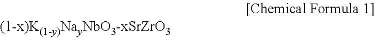

wherein x and y are as defined in the specification.

### CROSS-REFERENCE TO RELATED APPLICATION

This application claims priority to and the benefit of Korean Patent Application No. 10-2025-0065715 filed with the Korean Intellectual Property Office on May 20, 2025, and Korean Patent Application No. 10-2025-0045285 filed with the Korean Intellectual Property Office on Apr. 8, 2025, the entire contents of which are incorporated herein by reference.

### BACKGROUND

### (a) Technical Field

The present disclosure relates to a dielectric ceramic, a method of preparing the same, and a multilayer ceramic capacitor including the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

As the electric vehicle market has grown recently, the demand for automotive-grade MLCCs is increasing. Accordingly, the development of dielectric materials with excellent temperature stability, which is an essential requirement for automotive-grade MLCCs, is required.

### SUMMARY

An embodiment provides a dielectric ceramic having a high dielectric constant and excellent temperature stability.

Another embodiment provides a method of preparing the dielectric ceramic.

Another embodiment provides a multilayer ceramic capacitor having a high dielectric constant and excellent temperature stability.

An embodiment provides a dielectric ceramic including a KNN-SZ compound represented by Chemical Formula 1 and iron oxide.

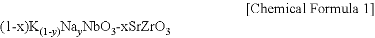

(In Chemical Formula 1, 0.10≤x≤0.20 and 0.40≤y≤0.50)

The iron oxide may include at least one selected from a group consisting of Fe₂O₃, FeO, and Fe₃O₄.

The iron oxide may be included in an amount of more than about 0 part by mole and less than or equal to about 4 parts by mole based on 100 parts by mole of the KNN-SZ compound.

The dielectric ceramic may include, based on the total amount of elements in the dielectric ceramic, about 1 mol % to about 10 mol % of K, about 1 mol % to about 10 mol % of Na, about 10 mol % to about 20 mol % of Nb, about 0.5 mol % to about 5 mol % of Sr, about 0.5 mol % to about 5 mol % of Zr, and about 0.1 mol % to about 1 mol % of Fe.

The dielectric ceramic may include a plurality of grains.

At least one of the plurality of grains may have a rectangular parallelepiped shape.

An average grain size of the dielectric ceramic may be about 230 nm to about 400 nm.

A relative density of the dielectric ceramic may be about 95% or more and about 100% or less.

Another embodiment provides a multilayer ceramic capacitor including a capacitor body including a dielectric layer and an internal electrode layer, and an external electrode disposed on an outer surface of the capacitor body, wherein the dielectric layer comprises a dielectric ceramic comprising a KNN-SZ compound represented by Chemical Formula 1 and iron oxide.

Another embodiment provides a method of preparing a dielectric ceramic including preparing a mixture by mixing a K-containing compound, a Na-containing compound, a Nb-containing compound, a Sr-containing compound, a Zr-containing compound, and iron oxide; preparing a pellet by calcining and compressing the mixture; and sintering the pellet to prepare the dielectric ceramic including a KNN-SZ compound represented by Chemical Formula 1 and iron oxide.

The iron oxide may be mixed in an amount of more than about 0 part by mole and less than or equal to about 4 parts by mole based on 100 parts by mole of the KNN-SZ compound.

The calcining may be performed at a temperature of about 800° C. to about 1000° C.

The sintering may be performed at a temperature of about 1100° C. to about 1300° C.

The dielectric ceramic according to an embodiment can have both a high dielectric constant and excellent temperature stability. Multilayer ceramic capacitors using these dielectric ceramics have a high dielectric constant and improved temperature stability, so they can be useful in automotive applications.

### BRIEF DESCRIPTION OF THE DRAWINGS

FIG. 1 is a perspective view illustrating a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure by disassembling the capacitor body of FIG. 1.

FIG. 5 is a scanning electron microscope (SEM) analysis image of the surface of the dielectric ceramic according to Example 1.

FIG. 6 is a scanning electron microscope (SEM) analysis image of the surface of the dielectric ceramic according to Example 2.

FIG. 7 is a scanning electron microscope (SEM) analysis image of the surface of the dielectric ceramic according to Example 3.

FIG. 8 is a scanning electron microscope (SEM) analysis image of the surface of the dielectric ceramic according to Example 4.

FIG. 9 is a scanning electron microscope (SEM) analysis image of the surface of the dielectric ceramic according to Example 5.

FIGS. 10A to 10G are scanning electron microscope-energy dispersive spectroscopy (SEM-EDS) mapping analysis images of the surface of the dielectric ceramic according to Example 2.

FIG. 11 is a graph showing the average grain size of dielectric ceramics according to Examples 1 to 5.

FIG. 12 is a graph showing the average grain size of dielectric ceramics according to Comparative Example 2, Example 2, and Examples 6 to 8.

FIG. 13 is a graph showing the relative density of dielectric ceramics according to Examples 1 to 5.

FIG. 14 is a graph showing the relative density of dielectric ceramics according to Comparative Example 2, Example 2, and Examples 6 to 8.

FIG. 15 is a graph showing changes in dielectric properties with frequency for dielectric ceramics according to Examples 1 to 5.

FIG. 16 is a graph showing changes in dielectric properties with temperature for dielectric ceramics according to Examples 1 to 5.

FIG. 17 is a graph showing changes in dielectric constant with temperature for dielectric ceramics according to Examples 1 to 5.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

### Dielectric Ceramic

KNN ceramics, denoted as (K,Na)NbO₃, are being studied as environmentally friendly, lead-free piezoelectric materials due to their high Curie temperature of approximately 420° C. and excellent piezoelectric and ferroelectric properties. The piezoelectric properties of these KNN ceramics are being improved through the introduction of various additives and composition control. In particular, interest in the energy storage capacity of KNN ceramics and their applicability as next-generation MLCCs has been increasing recently, and research on this topic is being actively conducted.

KNN ceramics have a relatively low dielectric constant (Er) of about 700 to about 800. However, the introduction of additives can significantly improve dielectric properties and energy storage performance. Various additives can change the crystal structure of KNN ceramics and improve polarization characteristics, so KNN-based ceramics can be useful as MLCC materials.

A dielectric ceramic according to an embodiment may include a KNN-SZ compound represented by Chemical Formula 1 and iron oxide.

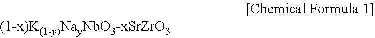

(In Chemical Formula 1, 0.10≤x≤0.20 and 0.40≤y≤0.50)

The KNN-SZ compound introduces SrZrO₃ into KNN ceramic, exhibits relaxor ferroelectric behavior, and can have temperature stability with minimal change in dielectric constant over a wide temperature range. In other words, the dielectric ceramic including the KNN-SZ compound can exhibit a high dielectric constant of about 1900 or higher while having excellent temperature stability, that is, temperature stability satisfying the characteristic that change in dielectric constant is within −15% to +15% in a temperature range of −55° C. to 200° C.

In addition, the dielectric constant of the KNN-SZ compound can be improved by introducing iron oxide as a sintering agent. The sintering agent is an element for promoting densification, reducing sintering temperature, and improving dielectric properties. When Fe³⁺ is doped into the B-site, i.e., Nb site, of KNN ceramic, oxygen vacancies can be formed due to the valence difference. The formation of oxygen vacancies can contribute to grain growth by promoting mass transportation. Additionally, lattice distortion caused by the difference in ionic radii between Fe³⁺ (0.645 Å) and Nb⁵⁺ (0.64 Å) can lead to tilting of the surrounding oxygen octahedra. This tilted structure easily reacts to an external electric field, and thus an increase in dielectric constant can be expected due to the addition of iron oxide.

That is, by introducing SrZrO₃ into KNN ceramics, the KNN-based ceramics are transformed from normal ferroelectrics to relaxor ferroelectrics, thereby securing stable dielectric properties over a wide temperature range. In addition, by introducing iron oxide into KNN ceramics, grain growth and lattice distortion can be induced, which can significantly improve the dielectric constant.

Therefore, the dielectric ceramic according to an embodiment can simultaneously implement high dielectric constant and excellent temperature stability, and thus can be useful in multilayer ceramic capacitors for automotive applications operating in high-temperature environments.

In Chemical Formula 1, x represents the mole fraction of SrZrO₃, 0.10≤x≤0.20, and may be, for example, 0.11≤x≤0.19, 0.11≤x≤0.18, or 0.11≤x≤0.17. Also, in Chemical Formula 1, 0.40≤y≤0.50, and for example, 0.42≤y≤0.50, or 0.45≤y≤0.50. When x and y satisfy the above ranges, temperature stability can be greatly improved with stable dielectric properties over a wide temperature range.

The iron oxide may include one or more selected from Fe₂O₃, FeO, and Fe₃O₄, and may be, for example, Fe₂O₃.

The iron oxide may be included in an amount of more than about 0 part by mole and less than or equal to about 4 parts by mole based on 100 parts by mole of the KNN-SZ compound, for example, about 0.1 part by mole to about 4 parts by mole, about 0.5 part by mole to about 4 parts by mole, or about 1 part by mole to about 4 parts by mole. When iron oxide is included within the above content range, grain growth and lattice distortion can be easily induced, thereby greatly improving the dielectric constant.

The dielectric ceramic may include elements of K, Na, Nb, Sr, Zr, and Fe. Specifically, the dielectric ceramic may include about 1 mol % to about 10 mol % of K, about 1 mol % to about 10 mol % of Na, about 10 mol % to about 20 mol % of Nb, about 0.5 mol % to about 5 mol % of Sr, about 0.5 mol % to about 5 mol % of Zr, and about 0.1 mol % to about 1 mol % of Fe, based on the total amount of elements included in the dielectric ceramic. For example, the dielectric ceramic may include about 6 mol % to about 8 mol % of K, about 6 mol % to about 8 mol % of Na, about 15 mol % to about 18 mol % of Nb, about 1 mol % to about 3 mol % of Sr, about 1 mol % to about 3 mol % of Zr, and about 0.2 mol % to about 0.5 mol % of Fe, based on the total amount of elements included in the dielectric ceramic.

When the component contents of the dielectric ceramic are within the above ranges, a high dielectric constant and excellent temperature stability can be achieved simultaneously.

For example, the dielectric ceramic may be composed of a KNN-SZ compound represented by Chemical Formula 1 and iron oxide.

The composition and content of the dielectric ceramic may be confirmed through scanning electron microscope-energy dispersive spectroscopy (SEM-EDS) analysis.

Specifically, the surface of the dielectric ceramic may be polished through a polishing process. The polishing process may use abrasive papers with grit sizes of 400, 1000, and 2000. The grit size of the abrasive paper refers to its roughness, and refers to the number of abrasive particles per unit area. The polishing process may be carried out sequentially from coarse-grit abrasive paper to fine-grit abrasive paper, and the rotation speed of the polisher can be controlled within a range of 100 rpm to 200 rpm. Next, the surface sample of the polished dielectric ceramic may be divided into three parts, an upper region, a central region, and a lower region, and scanning electron microscope (SEM) analysis may be performed on each region. SEM analysis may be performed under conditions of 15 kV acceleration voltage and 30k magnification. Next, energy dispersive spectroscopy (EDS) mapping analysis may be performed on the SEM images of each obtained surface sample to confirm the elements detected in the corresponding region and their contents. For example, the content of each element may be obtained by specifying five equally spaced points in the SEM image of each region and taking the average value of the content of each element at a total of 15 points.

The dielectric ceramic may have a microstructure including a plurality of grains. At least one of the plurality of grains may have a rectangular parallelepiped shape.

The microstructure of the dielectric ceramic may be confirmed through scanning electron microscope (SEM) analysis. Specifically, the microstructure of the dielectric ceramic may be confirmed through the SEM image of each surface sample obtained by the above-described method.

The average grain size of the dielectric ceramic may be from about 230 nm to about 400 nm, for example from about 250 nm to about 390 nm, from about 280 nm to about 380 nm, or from about 300 nm to about 370 nm. When the average grain size of the dielectric ceramic is within the above range, a high dielectric constant and excellent temperature stability can be achieved simultaneously.

The average grain size of the dielectric ceramic is the average value of size of a plurality of grains, and each grain size is the average value of the major axis, i.e., the longest diameter, and the minor axis, i.e., the shortest diameter, of the grain.

The average grain size of dielectric ceramic may be measured by scanning electron microscope (SEM) analysis. Specifically, the average value of size of a plurality of grains may be measured from the SEM image of the surface sample obtained by the above-described method. For example, the average grain size of the dielectric ceramic may be obtained by specifying 10 equally spaced grains in the SEM images of each of the upper, central, and lower regions obtained, and taking the average value of a total of 30 grain sizes. Here, the size of each grain may be obtained as the average value of the major and minor axes of the grain.

A relative density of the dielectric ceramic may be from about 95% to about 100%, for example from about 96% to about 100%, from about 96.5% to about 100%, or from about 97% to about 100%. When the relative density of the dielectric ceramic is within the above range, a high dielectric constant and excellent temperature stability may be achieved simultaneously.

The relative density of the dielectric ceramic may be measured using an Archimedes density measurement method. Specifically, the relative density of the dielectric ceramic may be obtained by measuring suspended mass in water, saturated mass, and dry mass to calculate the bulk density, and then dividing the bulk density by the theoretical density and multiplying the result by 100. At this time, a scale capable of measuring up to the fourth decimal place (unit: g) may be used, and when measuring the suspended mass in water, distilled water (DI water) may be used for measurement.

The above-mentioned dielectric ceramic may be prepared by the following method.

The dielectric ceramic including the KNN-SZ compound represented by Chemical Formula 1 and iron oxide may be prepared by preparing a mixture by mixing a K-containing compound, a Na-containing compound, a Nb-containing compound, a Sr-containing compound, a Zr-containing compound, and iron oxide; preparing a pellet by calcining and compressing the mixture; and sintering the pellet.

The K-containing compound, the Na-containing compound, the Nb-containing compound, the Sr-containing compound, and the Zr-containing compound may be in one or more forms selected from oxides, nitrides, and salt compounds, for example, in the form of oxides.

The iron oxide may include one or more selected from Fe₂O₃, FeO, and Fe₃O₄.

The iron oxide may be mixed in an amount of more than about 0 part by mole and less than or equal to about 4 parts by mole based on 100 parts by mole of the finally obtained KNN-SZ compound, for example, about 0.1 part by mole to about 4 parts by mole, about 0.5 part by mole to about 4 parts by mole, or about 1 part by mole to about 4 parts by mole. When iron oxide is mixed within the above content range, it is easy to induce grain growth and lattice distortion, which can greatly improve the dielectric constant

The mixture may be obtained by mixing each raw material by at least one method selected from the wet ball milling method, dry ball milling method, high-speed blading method, bead ball method, jet mill method, mechanical grinding method, ultrasonic method, and cryogenic method.

The calcining may be performed at a temperature of about 800° C. to about 1000° C., for example at a temperature of about 850° C. to about 950° C.

Additionally, the calcining may be performed for about 3 hours to about 6 hours, for example, for about 3 hours to about 5 hours. When calcining is performed within the above temperature range, both a high dielectric constant and excellent temperature stability can be achieved simultaneously.

The sintering may be performed at a temperature of about 1000° C. to about 1300° C., for example about 1100° C. to about 1290° C., about 1120° C. to about 1280° C., about 1140° C. to about 1260° C., or about 1150° C. to about 1250° C. Additionally, the sintering may be performed for about 2 hours to about 6 hours, for example, for about 2 hours to about 5 hours. When sintering is performed within the above temperature range, a high dielectric constant and excellent temperature stability can be achieved simultaneously.

### Multilayer Ceramic Capacitor

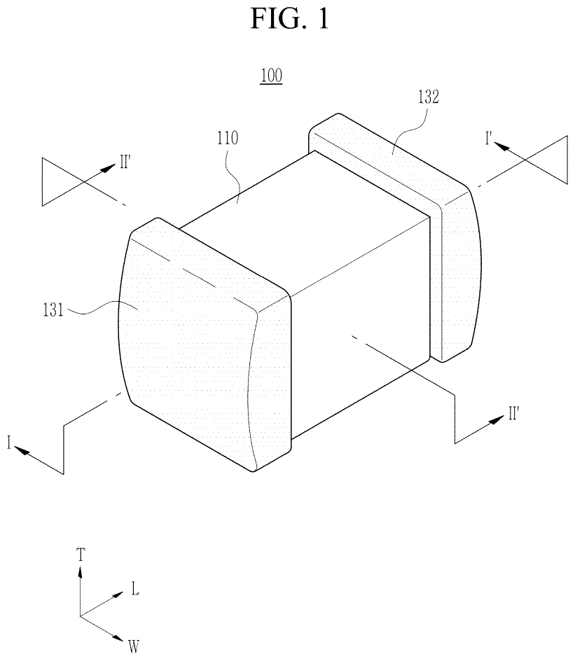

Hereinafter, a multilayer ceramic capacitor including the above-described dielectric ceramic will be described with reference to FIGS. 1 to 4.

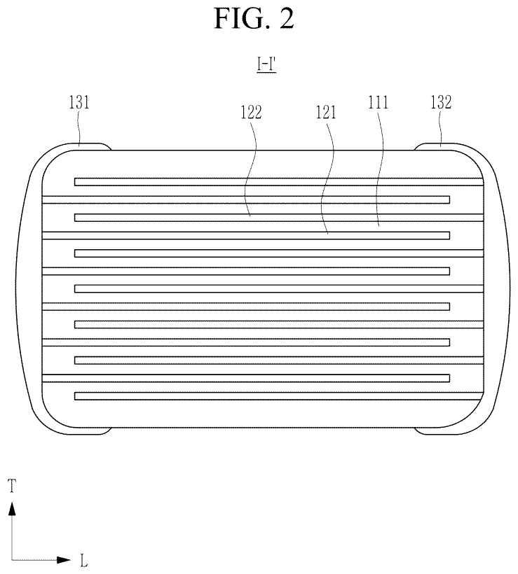

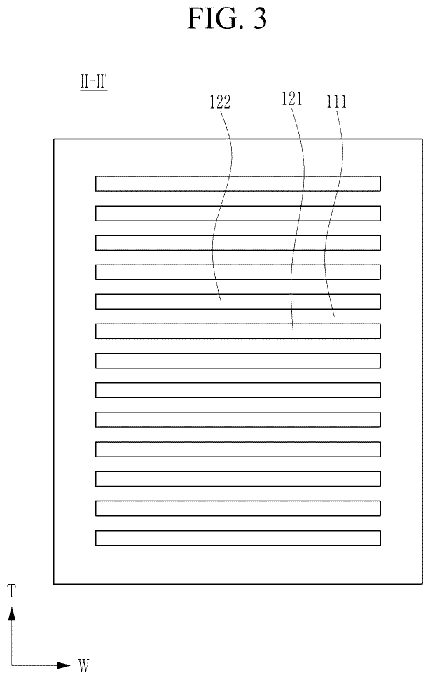

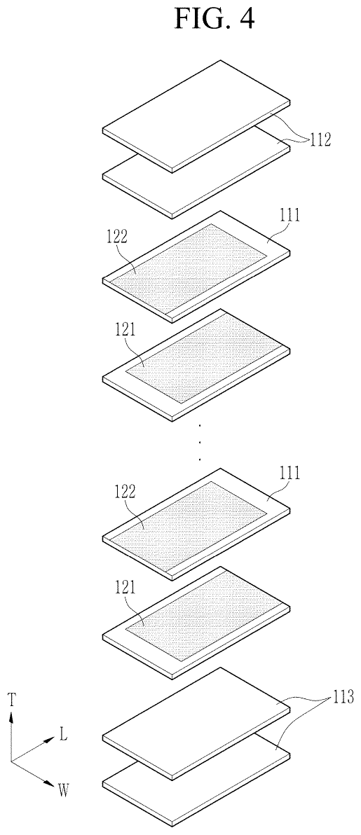

FIG. 1 is a perspective view showing a multilayer ceramic capacitor according to an embodiment, FIG. 2 is a cross-sectional view of the multilayer ceramic capacitor taken along line I-I′ of FIG. 1, FIG. 3 is a cross-sectional view of the multilayer ceramic capacitor taken along line II-II′ of FIG. 1, and FIG. 4 is an exploded perspective view illustrating the stacked structure by disassembling the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor according to an embodiment includes the capacitor body 110 and external electrodes 131 and 132 disposed on an outer surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately stacked, which contributes to forming capacitance of the multilayer capacitor 100. Specifically, the active region may be a region where the first internal electrode layer 121 and the second internal electrode layer 122 stacked along the thickness direction (T-axis direction) overlap.

The cover regions 112 and 113 are thickness-direction marginal portions, and may be positioned on the first and second surfaces of the active region A in the thickness direction (T-axis direction), respectively. The cover regions 112 and 113 may be a single dielectric layer 111 or two or more dielectric layers 111 stacked on the upper and lower surfaces of the active region A, respectively.

Additionally, the capacitor body 110 may further include side margin regions.

The side margin regions may be located on opposite side ends of the active region in the width direction (W-axis direction), that is, on the fifth surface and the sixth surface, respectively. The side margin regions may be located on opposite side ends of the active region A in the width direction (W-axis direction), that is, on the fifth surface and the sixth surface, respectively.

The cover regions 112 and 113 and the side margin regions serve to prevent damage to the first internal electrode layer 121 and the second internal electrode layer 122 due to physical or chemical stress.

The dielectric layer 111 according to an embodiment may include the dielectric ceramic described above.

That is, according to an embodiment, by applying the dielectric ceramic in which SrZrO₃ and iron oxide are introduced into KNN ceramic, specifically the dielectric ceramic including a KNN-SZ compound represented by Chemical Formula 1 and iron oxide, as a dielectric layer material, a multilayer ceramic capacitor having both a high dielectric constant and excellent temperature stability can be secured. Accordingly, it can contribute to the technological improvement of multilayer ceramic capacitors for automotive applications operating in high-temperature environments.

In addition to the above-described dielectric ceramic, the dielectric layer 111 may further include one or more auxiliary elements selected from manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 0.1 μm to about 8 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 can be measured by placing the multilayer ceramic capacitor 100 in an epoxy mixing solution, curing it, polishing it, and then ion milling it, and then analyzing it using a scanning electron microscope (SEM). SEM can be measured under conditions of, for example, 10 kV and a magnification of 100 times, and can be measured so that at least 1 layer, 3 layers, 5 layers, or 10 layers of dielectric layers 111 are visible in the active region where the dielectric layer 111 and the internal electrode layers 121 and 122 intersect. In the SEM image, the average thickness of the dielectric layer can be obtained by taking the central point of the length direction (L-axis direction) or width direction (W-axis direction) of the dielectric layer 111 as a reference point in the scanning electron microscope (SEM) image, and taking the mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted. In addition, by extending this average value measurement to 10 dielectric layers and measuring the average value, the average thickness of the dielectric layer can be more generalized.

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by the dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 include a conductive metal, and may include at least one selected from among metals such as Ni, Cu, Ag, Pd, Au, and alloys thereof.

The internal electrode layers 121 and 122 can be formed using a conductive paste including the conductive metal. The printing method for the conductive paste can be either screen printing or gravure printing.

Each average thickness of the first internal electrode layer 121 and the second internal electrode layer 122 may be about 0.1 μm to about 2 μm.

The average thickness of the first internal electrode layer 121 and the second internal electrode layer 122 may be measured by a scanning electron microscope (SEM) analysis. Specifically, in the SEM image of the cross-sectional sample obtained by the same method as the method for measuring the average thickness of the dielectric layer 111, the average thickness of the internal electrode layers can be obtained by taking the central point of the length direction (L-axis direction) or width direction (W-axis direction) of each of the internal electrode layers 121 and 122 as a reference point, and taking the mean value of the thickness of each of the internal electrode layers 121 and 122 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within each of the internal electrode layers 121 and 122, and if all 10 points are not positioned within each of the internal electrode layers 121 and 122, the position of the reference point may be changed, or the interval between the 10 points may be adjusted. In addition, by extending this average value measurement to 10 internal electrode layers and measuring the average value, the average thickness of the internal electrode layers can be more generalized.

The capacitor body 110 may be formed by firing a stacking structure in which the plurality of dielectric layers 111 and internal electrode layers 121 and 122 are stacked.

The external electrodes 131 and 132, i.e., the first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces or the fifth and sixth surfaces of the capacitor body 110. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and alloys thereof, or combinations thereof, and may include for example, copper (Cu) or a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the external electrodes 131 and 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in alloys thereof. For example, the plating layer may be a nickel (Ni) plating layer or a tin (Sn) plating layer, and may be in a form in which a nickel (Ni) plating layer and a tin (Sn) plating layer are sequentially stacked, or may be in a form in which a tin (Sn) plating layer, a nickel (Ni) plating layer, and a tin (Sn) plating layer are sequentially stacked. In addition, the plating layer may include a plurality of nickel (Ni) plating layers and/or a plurality of tin (Sn) plating layers.

The plating layer may improve mountability to the substrate, structural reliability, durability to the outside, heat resistance, and equivalent series resistance (ESR) of the multilayer ceramic capacitor 100.

Hereinafter, a method of manufacturing the above-described multilayer ceramic capacitor 100 will be described.

A multilayer ceramic capacitor 100 may be manufactured by preparing a dielectric slurry including the above-mentioned dielectric ceramic; manufacturing a dielectric green sheet using the dielectric slurry and forming a conductive paste layer on a surface of the dielectric green sheet; manufacturing a dielectric green sheet stack by stacking a plurality of the dielectric green sheets on which the conductive paste layer is formed; manufacturing a capacitor body including a dielectric layer and an internal electrode layer by firing the dielectric green sheet stack; and forming an external electrode on a surface of the capacitor body.

As described above, the dielectric ceramic may be prepared by mixing a K-containing compound, a Na-containing compound, a Nb-containing compound, a Sr-containing compound, a Zr-containing compound, and iron oxide to prepare a mixture, calcining the mixture, compressing it to prepare pellets, and then sintering the pellets.

The dielectric slurry may further include an auxiliary component powder, i.e., an auxiliary component-containing compound.

The auxiliary component-containing compound may include a compound containing one or more auxiliary components selected from manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

The auxiliary component-containing compound may be at least one of an oxide, nitride and salt compound of the auxiliary component, and may also be a compound in the form of a sol dispersed in an organic solvent.

The auxiliary component-containing compound may be included in an amount of about 0.9 part by mole to about 1.5 parts by mole of the auxiliary component based on 100 parts by mole of the dielectric ceramic.

The dielectric slurry may be prepared by additionally mixing additives such as a dispersant, a binder, a plasticizer, a lubricant, an antistatic agent, and a solvent.

The dispersant may include for example at least one selected from a phosphoric acid ester-based dispersant and a polycarboxylic acid-based dispersant. The dispersant may be mixed in an amount of about 0.1 part by weight to about 5 parts by weight, for example, about 0.3 part by weight to about 3 parts by weight, based on 100 parts by weight of the dielectric ceramic. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyralresin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the dielectric ceramic. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the dielectric ceramic. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight, based on 100 parts by weight of the dielectric ceramic. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes the internal electrode layer after firing, a conductive paste can be prepared by mixing a conductive powder made of a conductive metal or an alloy thereof, a binder, and a solvent. A conductive paste layer is formed by applying the conductive paste in a predetermined pattern on a surface of the dielectric green sheet using various printing methods such as screen printing or a transfer method.

The conductive powder may include nickel (Ni) or a nickel (Ni) alloy.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be manufactured after binder removal treatment (calcinating) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 hour to about 8 hours, for example, about 1 hour to about 3 hours. Additionally, the firing may be performed in an air atmosphere, i.e. an oxygen atmosphere.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a humidifier may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepared capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on a surface of the manufactured capacitor body 110.

As an example, a paste for forming the sintered metal layer may be applied to the external electrode and then sintered to form the sintered metal layer.

The paste for forming the sintered metal layer may include a conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent such as terpineol, butylcarbitol, alcohol, methyl ethyl ketone, acetone, toluene, and the like, or aqueous solvent

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent such as terpineol, butylcarbitol, alcohol, methyl ethyl ketone, acetone, and toluene, or aqueous solvent.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, a plating layer is formed on the outside of the conductive resin layer.

For example, the plating layer may be formed by a plating method, such as electrolytic plating, or sputtering.

Hereinafter, the embodiments are illustrated in more detail with reference to examples. However, these examples are exemplary, and the scope of claims is not limited thereto.

### Preparation of Dielectric Ceramics

### Examples 1 to 8 and Comparative Examples 1 and 2

K₂CO₃, Na₂CO₃, Nb₂O₅, SrCO₃, ZrO₂, and Fe₂O₃ were uniformly mixed in an ethanol medium. The obtained mixture was calcined at 900° C. for 3 hours, and then ball milled for 24 hours to obtain a powder composed of a KNN-SZ compound represented by Chemical Formula 1 and Fe₂O₃. Next, the obtained powder was uniaxially pressed to prepare a disc-shaped pellet with a diameter of 16 mm. The prepared pellets were sintered at a temperature of 1250° C. for 2 hours in an air atmosphere to prepare a dielectric ceramic including a KNN-SZ compound represented by Chemical Formula 1 and Fe₂O₃.

At this time, K₂CO₃, Na₂CO₃, Nb₂O₅, SrCO₃, and ZrO₂ were mixed in contents having a composition of (1−x)K_{0.5}Na_{0.5}NbO₃₋ₓSrZrO₃, where the x value is as shown in Table 1 below. Additionally, Fe₂O₃ was mixed in an amount ranging from 0 part by mole to 2 parts by mole based on 100 parts by mole of the KNN-SZ compound, as shown in Table 1 below.

TABLE 1

| | | Fe₂O₃ (parts |
|---|---|---|
| | KNN—SZ compound | by mole) |
| Example 1 | 0.89K_{0.5}Na_{0.5}NbO₃—0.11SrZrO₃ (x = 0.11) | 2 |
| Example 2 | 0.87K_{0.5}Na_{0.5}NbO₃—0.13SrZrO₃ (x = 0.13) | 2 |
| Example 3 | 0.86K_{0.5}Na_{0.5}NbO₃—0.14SrZrO₃ (x = 0.14) | 2 |
| Example 4 | 0.85K_{0.5}Na_{0.5}NbO₃—0.15SrZrO₃ (x = 0.15) | 2 |
| Example 5 | 0.83K_{0.5}Na_{0.5}NbO₃—0.17SrZrO₃ (x = 0.17) | 2 |
| Example 6 | 0.87K_{0.5}Na_{0.5}NbO₃—0.13SrZrO₃ (x = 0.13) | 1 |
| Example 7 | 0.87K_{0.5}Na_{0.5}NbO₃—0.13SrZrO₃ (x = 0.13) | 3 |
| Example 8 | 0.87K_{0.5}Na_{0.5}NbO₃—0.13SrZrO₃ (x = 0.13) | 4 |
| Comparative | K_{0.5}Na_{0.5}NbO₃ | 0 |
| Example 1 | | |
| Comparative | 0.87K_{0.5}Na_{0.5}NbO₃—0.13SrZrO₃ (x = 0.13) | 0 |
| Example 2 | | |

### (Manufacturing of Multilayer Ceramic Capacitors)

A dielectric slurry was prepared using each of the dielectric ceramics prepared in Examples 1 to 8 and Comparative Examples 1 and 2. The dielectric slurry was prepared by mechanical milling after adding ethanol/toluene, a wetting dispersant, and polyvinyl butyral (PVB) as a binder together using zirconia balls (ZrO₂ balls) as a dispersion medium.

The prepared dielectric slurry was used by using a head discharge type on-roll forming coater to manufacture a dielectric green sheet.

A conductive paste layer including nickel (Ni) was printed on a surface of the dielectric green sheet, and the dielectric green sheets on which the conductive paste layers were formed were stacked and pressed to manufacture a dielectric green sheet stack.

The dielectric green sheet stack was calcined at a temperature of 400° C. or less in a nitrogen atmosphere, and then fired at a temperature of 1300° C. or lower in an oxygen atmosphere.

Next, each multilayer ceramic capacitor was manufactured through processes such as forming of external electrodes and plating.

### Evaluation 1: SEM Analysis of Dielectric Ceramics

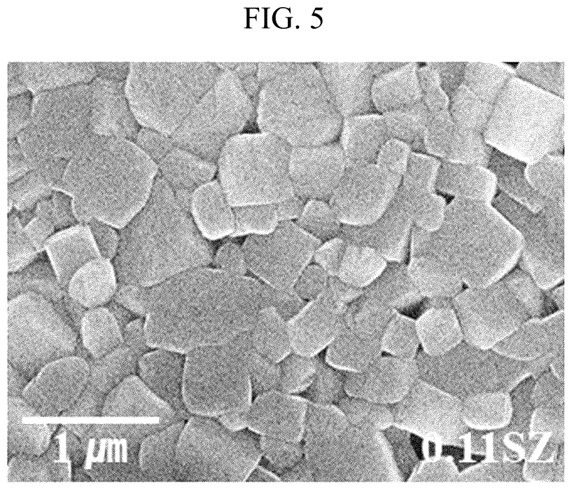

Scanning electron microscope (SEM) analysis was performed on the dielectric ceramics prepared in Examples 1 to 5 by the following method, and the results are shown in FIGS. 5 to 9.

The surface of each dielectric ceramic was polished through a polishing process. The polishing process was performed using abrasive papers with grit sizes of 400, 1000, and 2000, and was performed sequentially from abrasive papers with grit sizes of 400 which is coarse-grit abrasive paper to abrasive papers with grit sizes of 2000 which is fine-grit abrasive paper. The rotation speed of the polisher was controlled within the range of 100 rpm to 200 rpm. Next, the surface sample of the polished dielectric ceramic was divided into three parts, an upper region, a central region, and a lower region, and scanning electron microscope (SEM) analysis was performed on each region. SEM analysis was performed under conditions of 15 kV acceleration voltage and 30k magnification.

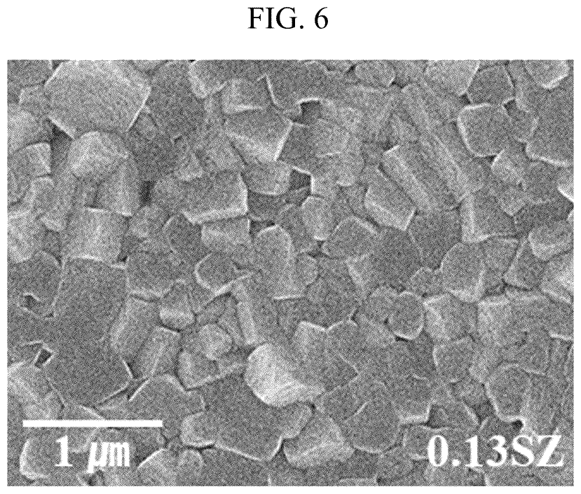

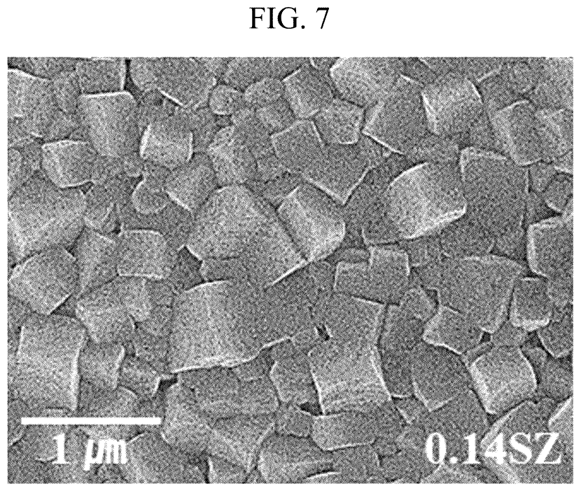

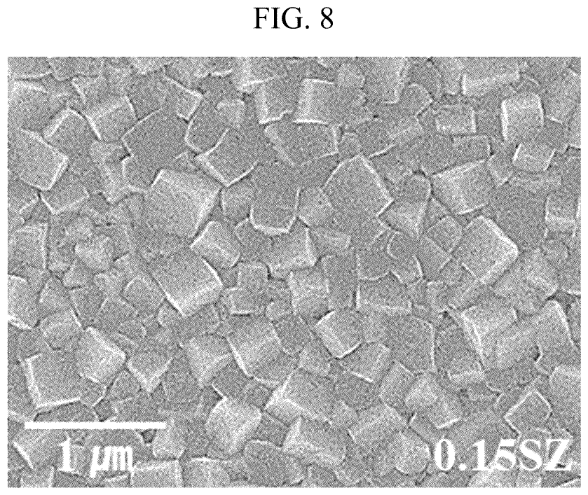

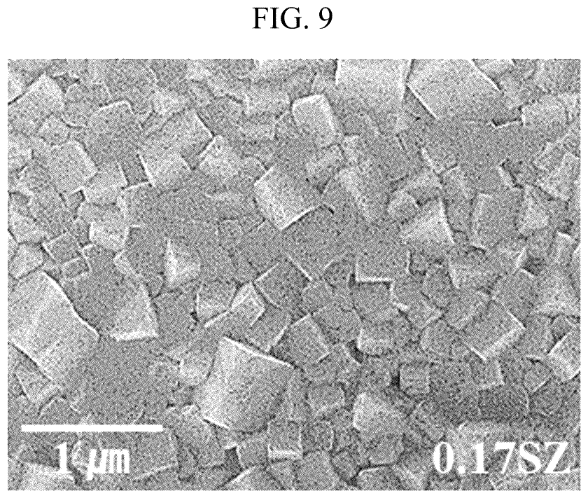

FIG. 5 is a scanning electron microscope (SEM) analysis image of the surface of the dielectric ceramic according to Example 1, FIG. 6 is a scanning electron microscope (SEM) analysis image of the surface of the dielectric ceramic according to Example 2, FIG. 7 is a scanning electron microscope (SEM) analysis image of the surface of the dielectric ceramic according to Example 3, FIG. 8 is a scanning electron microscope (SEM) analysis image of the surface of the dielectric ceramic according to Example 4, and FIG. 9 is a scanning electron microscope (SEM) analysis image of the surface of the dielectric ceramic according to Example 5.

Referring to FIGS. 5 to 9, it can be seen that the dielectric ceramics according to Examples 1 to 5 include a plurality of grains, and at least one of the plurality of grains has a rectangular parallelepiped shape. From this, the structure of the dielectric ceramic including the KNN-SZ compound having a molar fraction of SrZrO₃ in a predetermined range and iron oxide according to an embodiment can be confirmed.

### Evaluation 2: SEM-EDS Analysis of Dielectric Ceramics

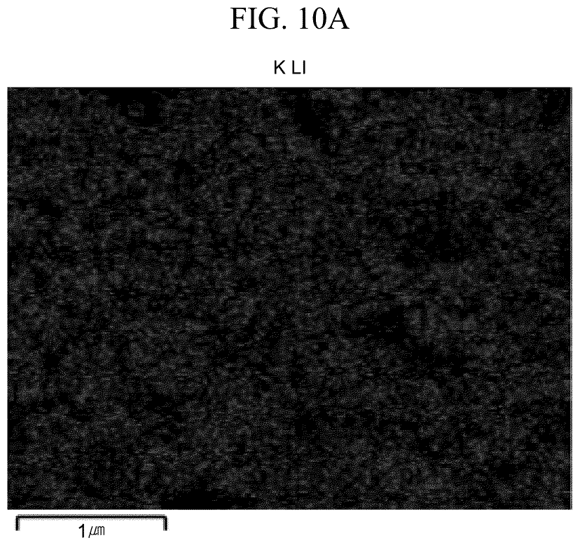

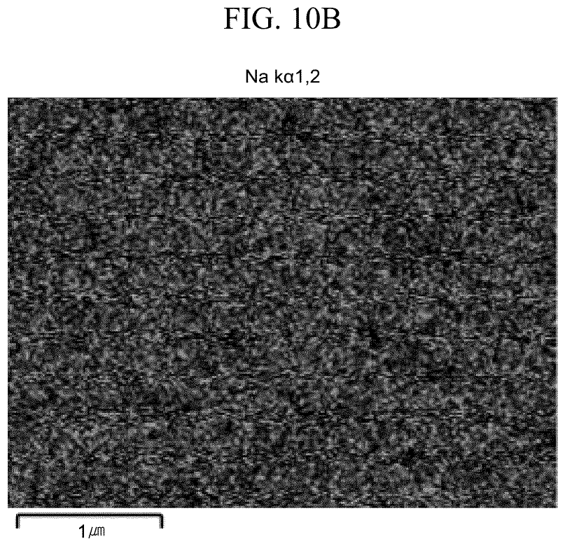

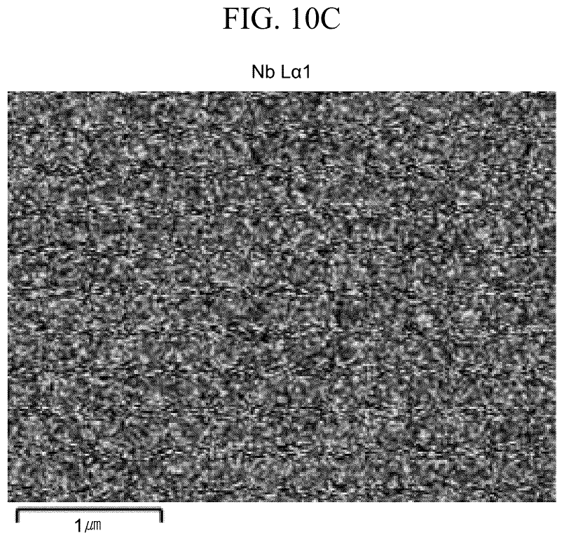

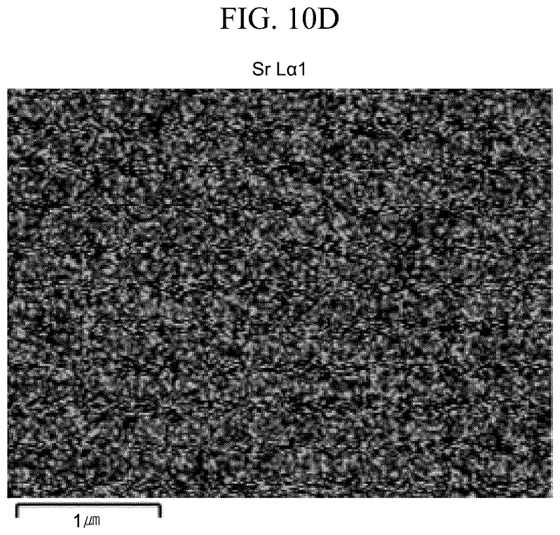

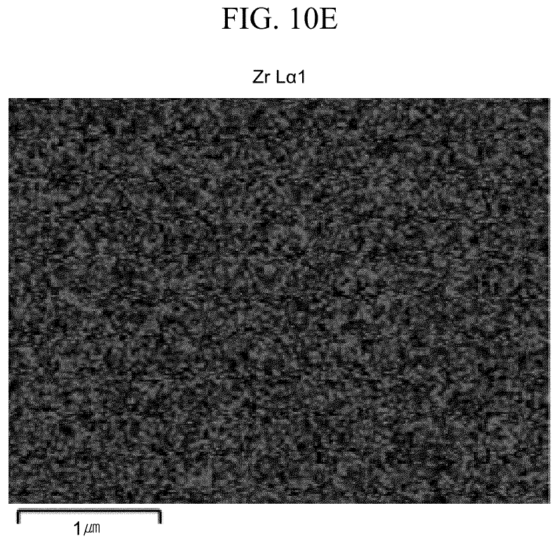

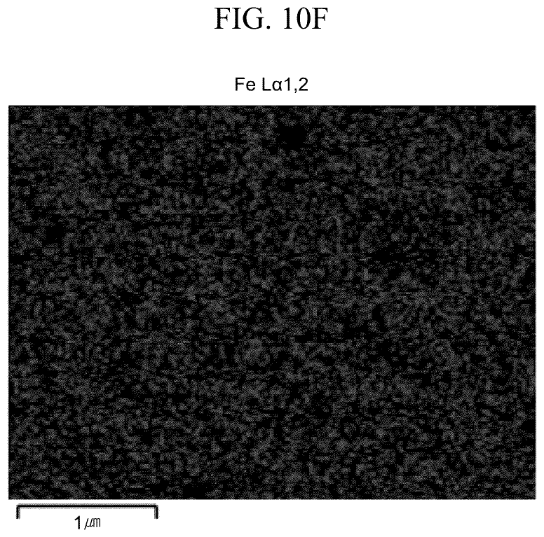

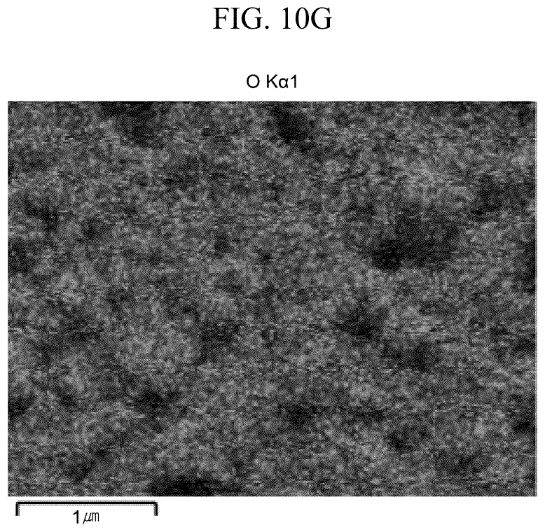

SEM-EDS analysis was performed on the dielectric ceramic prepared in Example 2 using the following method, and the results are shown in FIGS. 10A to 10G.

Energy dispersive spectroscopy (EDS) mapping analysis was performed on the SEM images of each surface sample obtained by the same method as in Evaluation 1 to identify the elements detected in the corresponding region and their contents. Here, the content of each element was obtained by designating five equally spaced points in the SEM image of each region and taking the average value of the content of each element at a total of 15 points.

FIGS. 10A to 10G are scanning electron microscope-energy dispersive spectroscopy (SEM-EDS) mapping analysis images of the surface of the dielectric ceramic according to Example 2.

Referring to FIGS. 10A to 10G, it can be seen that the dielectric ceramic according to Example 2 includes all of the elements of K, Na, Nb, Sr, Zr, Fe, and O, and the content of each element is 7.15 mol % of K, 7.15 mol % of Na, 16.99 mol % of Nb, 2.27 mol % of Sr, 2.22 mol % of Zr, 0.33 mol % of Fe, and 63.89 mol % of O.

### Evaluation 3: Average Grain Size of Dielectric Ceramics

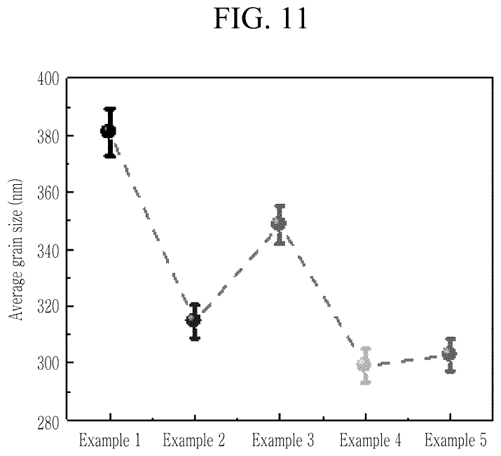

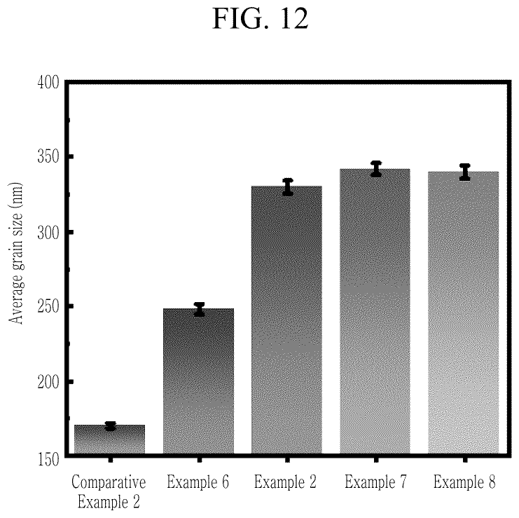

The average grain size for each dielectric ceramic prepared in Examples 1 to 8 and Comparative Example 2 was measured by the following method, and the results are shown in FIGS. 11 and 12.

In the SEM images of upper region, central region, and lower region of each surface sample obtained by the same method as Evaluation 1, 10 equally spaced grains were selected, the sizes of a total of 30 grains were measured, and then the average value was obtained. Here, the size of each grain was obtained as the average of the major and minor axes of the grain, i.e., the average of the longest and shortest diameters.

FIG. 11 is a graph showing the average grain size of dielectric ceramics according to Examples 1 to 5, and FIG. 12 is a graph showing the average grain size of dielectric ceramics according to Comparative Example 2, Example 2, and Examples 6 to 8.

Referring to FIG. 11, it can be seen that the average grain size of the dielectric ceramics according to Examples 1 to 5 having a molar fraction of SrZrO₃ in a predetermined range according to an embodiment is within a range of 230 nm to 400 nm. Also, referring to FIG. 12, in the case of Examples 2 and 6 to 8 where the content of iron oxide is in the range of more than about 0 part by mole and less than or equal to about 4 parts by mole based on 100 parts by mole of the KNN-SZ compound, it can be seen that the average grain size of the dielectric ceramic is in the range of 230 nm to 400 nm. On the other hand, in the case of Comparative Example 2 where iron oxide is not included, it can be seen that the grain size of the dielectric ceramic is very small.

### Evaluation 4: Relative Density of Dielectric Ceramics

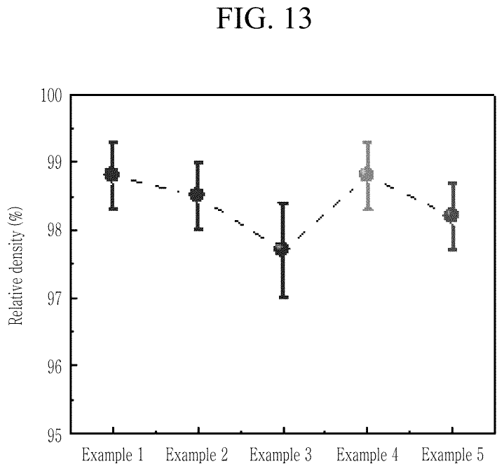

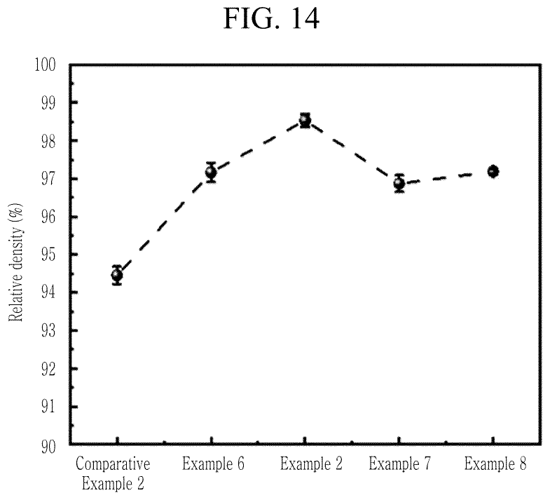

The relative density of each dielectric ceramic prepared in Examples 1 to 8 and Comparative Example 2 was measured by the following method, and the results are shown in FIGS. 13 and 14.

The relative density of each dielectric ceramic was measured using an Archimedes density measurement method. Specifically, the relative density of the dielectric ceramic was obtained by measuring suspended mass in water, saturated mass, and dry mass to calculate the bulk density, and then dividing the bulk density by the theoretical density and multiplying the result by 100. At this time, a scale capable of measuring up to the fourth decimal place (unit: g) was used, and when measuring the suspended mass in water, distilled water (DI water) was used for measurement.

FIG. 13 is a graph showing the relative density of dielectric ceramics according to Examples 1 to 5, and FIG. 14 is a graph showing the relative density of dielectric ceramics according to Comparative Example 2, Example 2, and Examples 6 to 8.

Referring to FIG. 13, it can be seen that the relative density of the dielectric ceramics according to Examples 1 to 5 having a molar fraction of SrZrO₃ in a predetermined range according to an embodiment example is 95% or more. Also, referring to FIG. 14, in the case of Examples 2 and 6 to 8 where the content of iron oxide is in the range of more than about 0 part by mole and less than or equal to about 4 parts by mole based on 100 parts by mole of the KNN-SZ compound, it can be seen that the relative density of the dielectric ceramic is 95% or more. On the other hand, in the case of Comparative Example 2 where iron oxide is not included, it can be seen that the relative density of the dielectric ceramic is seen to be the lowest.

### Evaluation 5: Dielectric Constant and Temperature Stability of Dielectric Ceramics

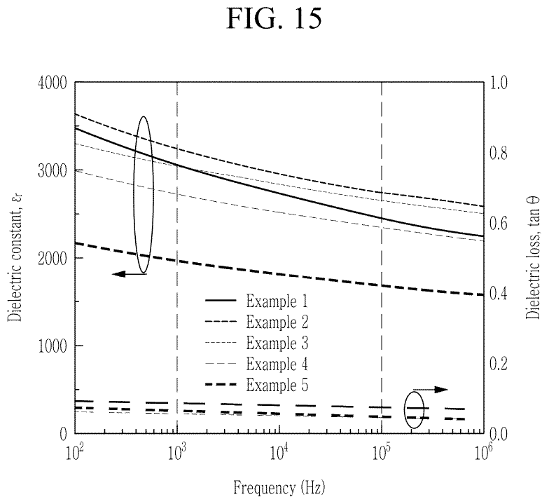

The dielectric constant and temperature stability of each dielectric ceramic prepared in Examples 1 to 8 and Comparative Examples 1 and 2 were evaluated by the following methods, and the results are shown in FIGS. 15 to 17 and Table 2 below.

The surface of each dielectric ceramic was polished through a polishing process. The polishing process was performed using abrasive papers with grit sizes of 400, 1000, and 2000, and was performed sequentially from abrasive papers with grit sizes of 400 which is coarse-grit abrasive paper to abrasive papers with grit sizes of 2000 which is fine-grit abrasive paper. The rotation speed of the polisher was controlled within the range of 100 rpm to 200 rpm. Next, silver (Ag) paste was uniformly applied to the surface of the polished specimen using a brush, and then heat-treated at 730° C. for 10 minutes in a small furnace to form an electrode. Afterwards, the side of the specimen was polished to remove the connection part between the top and bottom electrodes.

After measuring the diameter and thickness of the sample with electrodes formed on the top and bottom, the dielectric properties were measured at room temperature (25° C.) over a frequency range of 100 Hz to 1 MHz using an impedance analyzer (HP 4294A), and the dielectric constant was obtained using Equation 1. The results are shown in FIG. 15.

$$C = {ε}_{r} {ε}_{0} \frac{A}{d} \qquad [ Equation 1 ]$$

(In Equation 1, C is the capacitance (F), εᵣ is the relative dielectric constant, ε₀ is the vacuum dielectric constant (F/m), A is the area (m²), and d is the distance between the upper electrode and the lower electrode (m).

FIG. 15 is a graph showing changes in dielectric properties with frequency for dielectric ceramics according to Examples 1 to 5.

Referring to FIG. 15, Examples 1 to 5 exhibit dielectric constant (Er) values of 3062, 3210, 3048, 2718, and 1962 at 1 KHz and room temperature, respectively, and all exhibit small dielectric loss characteristics of less than 5% in the corresponding frequency range. From this, it can be seen that the dielectric ceramic according to an embodiment has a high dielectric constant and low dielectric loss.

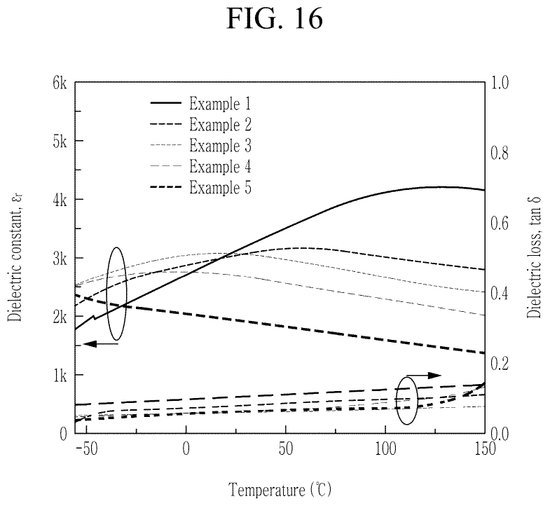

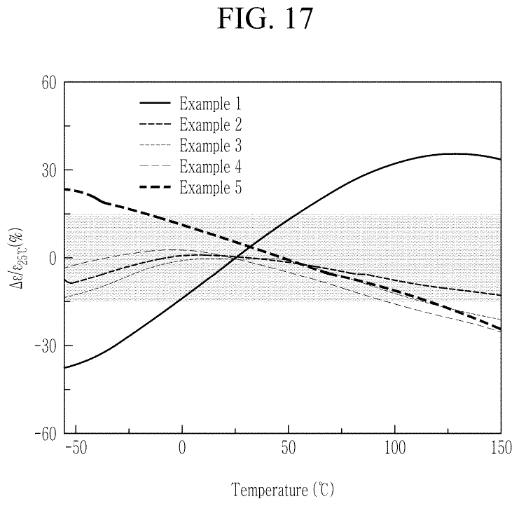

In addition, after measuring the diameter and thickness of the sample with electrodes formed on the top and bottom, the dielectric properties were measured at 1° C. intervals in the range of −55° C. to 150° C. under the conditions of 1 kHz frequency and 1V AC using a temperature test chamber (S&A 4220), and the dielectric constant was obtained using Equation 1. The results are shown in FIGS. 16 and 17.

FIG. 16 is a graph showing changes in dielectric properties with temperature for dielectric ceramics according to Examples 1 to 5, and FIG. 17 is a graph showing changes in dielectric constant with temperature for dielectric ceramics according to Examples 1 to 5.

In FIG. 17, Δε=(εᵣ−ε_{25° C.}) was calculated, and εᵣ and ε_{25° C.} are the dielectric constant values measured at a specific temperature (T) and 25° C., respectively.

Referring to FIGS. 16 and 17, in the case of Examples 1 to 5, the change in dielectric constant is not large within the temperature range of −55° C. to 150° C., and from this, it can be seen that the dielectric ceramic according to an embodiment has excellent temperature stability.

TABLE 2

| | | Dielectric | |
|---|---|---|---|
| | | constant | Temper- |
| | | (1 kHz, | ature |
| | KNN—SZ compound + iron oxide | 25° C.) | stability |
| Example 1 | 0.89K_{0.5}Na_{0.5}NbO₃—0.11SrZrO₃ + | 3062 | 0° C.-55° |
| | Fe₂O₃ 2 parts by mole | | C., ±15% |
| Example 2 | 0.87K_{0.5}Na_{0.5}NbO₃—0.13SrZrO₃ + | 3210 | −55° C.- |
| | Fe₂O₃ 2 parts by mole | | 150° |
| | | | C., ±15% |
| Example 3 | 0.86K_{0.5}Na_{0.5}NbO₃—0.14SrZrO₃ + | 3048 | −55° C.- |
| | Fe₂O₃ 2 parts by mole | | 110° |
| | | | C., ±15% |
| Example 4 | 0.85K_{0.5}Na_{0.5}NbO₃—0.15SrZrO₃ + | 2718 | −55° C.- |
| | Fe₂O₃ 2 parts by mole | | 95° |
| | | | C., ±15% |
| Example 5 | 0.83K_{0.5}Na_{0.5}NbO₃—0.17SrZrO₃ + | 1962 | −20° C.- |
| | Fe₂O₃ 2 parts by mole | | 105° |
| | | | C., ±15% |
| Example 6 | 0.87K_{0.5}Na_{0.5}NbO₃—0.13SrZrO₃ + | 3429 | −25° C.- |
| | Fe₂O₃ 1 part by mole | | 100° |
| | | | C., ±15% |
| Example 7 | 0.87K_{0.5}Na_{0.5}NbO₃—0.13SrZrO₃ + | 3351 | −25° C.- |
| | Fe₂O₃ 3 parts by mole | | 50° |
| | | | C., ±15% |
| Example 8 | 0.87K_{0.5}Na_{0.5}NbO₃—0.13SrZrO₃ + | 3302 | −25° C.- |
| | Fe₂O₃ 4 parts by mole | | 50° |
| | | | C., ±15% |
| Compar- | K_{0.5}Na_{0.5}NbO₃ | 400-900 | 0° C.-100° |
| ative | | | C., ±30% |
| Example 1 | | | |
| Compar- | 0.87K_{0.5}Na_{0.5}NbO₃—0.13SrZrO₃ | 2632 | −25° C.- |
| ative | | | 150° |
| Example 2 | | | C., ±30% |

From this, the dielectric ceramic according to an embodiment not only has a high dielectric constant and low dielectric loss, but also has excellent temperature stability, so it is useful as a dielectric material for multilayer ceramic capacitors for automotive applications operating in high-temperature environments.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: multilayer ceramic capacitor
110: capacitor body
111: dielectric layer
121: first internal electrode layer
122: second internal electrode layer
131: first external electrode
132: second external electrode

What is claimed is:

1. A dielectric ceramic comprising a KNN-SZ compound represented by Chemical Formula 1 and iron oxide; 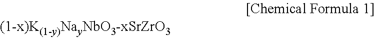
wherein 0.10≤x≤0.20 and 0.40≤y≤0.50.

2. The dielectric ceramic of claim 1, wherein
the iron oxide comprises at least one selected from a group consisting of Fe₂O₃, FeO, and Fe₃O₄.

3. The dielectric ceramic of claim 1, wherein
the iron oxide is included in an amount of more than 0 part by mole and less than or equal to 4 parts by mole, based on 100 parts by mole of the KNN-SZ compound.

4. The dielectric ceramic of claim 1, wherein
the dielectric ceramic comprises, based on a total amount of elements in the dielectric ceramic, 1 mol % to 10 mol % of K, 1 mol % to 10 mol % of Na, 10 mol % to 20 mol % of Nb, 0.5 mol % to 5 mol % of Sr, 0.5 mol % to 5 mol % of Zr, and 0.1 mol % to 1 mol % of Fe.

5. The dielectric ceramic of claim 1, wherein
the dielectric ceramic comprises a plurality of grains.

6. The dielectric ceramic of claim 5, wherein
at least one of the plurality of grains has a rectangular parallelepiped shape.

7. The dielectric ceramic of claim 5, wherein
an average grain size of the dielectric ceramic is in a range of 230 nm to 400 nm.

8. The dielectric ceramic of claim 1, wherein
a relative density of the dielectric ceramic is 95% or more and 100% or less.

9. A multilayer ceramic capacitor, comprising
a capacitor body including a dielectric layer and an internal electrode layer, and
an external electrode disposed on an outer surface of the capacitor body,
wherein the dielectric layer comprises a dielectric ceramic comprising a KNN-SZ compound represented by Chemical Formula 1 and iron oxide; 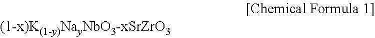
wherein 0.10≤x≤0.20 and 0.40≤y≤0.50.

10. The multilayer ceramic capacitor of claim 9, wherein
the iron oxide comprises at least one selected from a group consisting of Fe₂O₃, FeO, and Fe₃O₄.

11. The multilayer ceramic capacitor of claim 9, wherein
the iron oxide is included in an amount of more than 0 part by mole and less than or equal to 4 parts by mole, based on 100 parts by mole of the KNN-SZ compound.

12. The multilayer ceramic capacitor of claim 9, wherein
the dielectric ceramic comprises, based on a total amount of elements in the dielectric ceramic, 1 mol % to 10 mol % of K, 1 mol % to 10 mol % of Na, 10 mol % to 20 mol % of Nb, 0.5 mol % to 5 mol % of Sr, 0.5 mol % to 5 mol % of Zr, and 0.1 mol % to 1 mol % of Fe.

13. The multilayer ceramic capacitor of claim 9, wherein
the dielectric ceramic comprises a plurality of grains.

14. The multilayer ceramic capacitor of claim 13, wherein
at least one of the plurality of grains has a rectangular parallelepiped shape.

15. The multilayer ceramic capacitor of claim 13, wherein
an average grain size of the dielectric ceramic is in a range of 230 nm to 400 nm.

16. The multilayer ceramic capacitor of claim 9, wherein
a relative density of the dielectric ceramic is 95% or more and 100% or less.

17. A method of preparing a dielectric ceramic, comprising
preparing a mixture by mixing a K-containing compound, a Na-containing compound, a Nb-containing compound, a Sr-containing compound, a Zr-containing compound, and iron oxide;
preparing a pellet by calcining and compressing the mixture; and
sintering the pellet to prepare the dielectric ceramic including a KNN-SZ compound represented by Chemical Formula 1 and iron oxide; 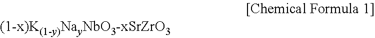
wherein 0.10≤x≤0.20 and 0.40≤y≤0.50.

18. The method of claim 17, wherein
the iron oxide is mixed in an amount of more than 0 part by mole and less than or equal to 4 parts by mole, based on 100 parts by mole of the KNN-SZ compound.

19. The method of claim 17, wherein
the calcining is performed at a temperature of 800° C. to 1000° C.

20. The method of claim 17, wherein
the sintering is performed at a temperature of 1100° C. to 1300° C.
